(19) United States
(12) Patent Application Publication
(10) Pub. No.: US 2022/0366614 A1
(43) Pub. Date: Nov. 17, 2022

(54) IMAGE GENERATION APPARATUS, IMAGE GENERATION METHOD, AND NON-TRANSITORY COMPUTER READABLE MEDIUM

(71) Applicant: NEC Corporation, Minato-ku, Tokyo (JP)

(72) Inventors: Masayuki ARIYOSHI, Tokyo (JP); Kazumine OGURA, Tokyo (JP); Tatsuya SUMIYA, Tokyo (JP); Shingo YAMANOUCHI, Tokyo (JP); Nagma Samreen KHAN, Tokyo (JP); Toshiyuki NOMURA, Tokyo (JP)

(73) Assignee: NEC Corporation, Minato-ku, Tokyo (JP)

(21) Appl. No.: 17/770,763

(22) PCT Filed: Oct. 25, 2019
(86) PCT No.: PCT/JP2019/042030

§ 371 Date: Apr. 21, 2022

(51) Int. Cl. G06T 11/00; G06T 3/40; G01S 17/04; G01S 17/894

(52) U.S. Cl. CPC G06T 11/00; G06T 3/40; G01S 17/04; G01S 17/894; G06T 2210/22

(57) ABSTRACT

A image processing apparatus (20) includes at least an acquisition unit (210), a processing unit (220), and an image generation unit (230). The acquisition unit (210) acquires an intermediate frequency signal from an irradiation apparatus (10). The processing unit (220) generates three-dimensional positional information about a subject by processing the intermediate frequency signal. The image generation unit (230) generates at least a first two-dimensional image and a second two-dimensional image, and displays the two-dimensional images on a display apparatus (30). The first two-dimensional image is, for example, an image when viewed from a direction in which the subject moves, and the second two-dimensional image is, for example, an image when viewed from an opposite direction.

### TECHNICAL FIELD

The present invention relates to an image generation apparatus, an image generation method, and a program.

### BACKGROUND ART

Carrying of a specific article may be regulated at a facility such as an airport. At such a facility, belongings of a person may be often inspected in a passage leading to the facility or at an entrance to the facility. There is an apparatus described in Patent Document 1 as a technique related to the inspection. The apparatus irradiates a person with a microwave from three directions, analyzes a reflection wave of the microwave, and thus generates an image.

### RELATED DOCUMENT

### Patent Document

[Patent Document 1] U.S. Patent Application Publication No. 2016/0216371 Specification

### DISCLOSURE OF THE INVENTION

### Technical Problem

By analyzing a reflection wave of an electromagnetic wave irradiated to a person, a three-dimensional shape of a subject such as a person and an accompaniment (for example, belongings of the person) of the subject can be estimated. Meanwhile, in order to efficiently inspect a plurality of subjects, an accompaniment needs to be efficiently recognized by a person.

An object of the present invention is to efficiently cause an accompaniment to be recognized by a person when a three-dimensional shape of a subject and an accompaniment of the subject is estimated by irradiating an electromagnetic wave and analyzing a reflection wave of the electromagnetic wave.

### Solution to Problem

The present invention provides an image generation apparatus used together with an irradiation apparatus, the irradiation apparatus including

a transmission unit that irradiates a region through which a subject passes with an electromagnetic wave having a wavelength of equal to or more than 30 micrometers and equal to or less than one meter, and

a reception unit that receives a reflection wave acquired from the electromagnetic wave being reflected by the subject, and generates an IF signal being an intermediate frequency signal from the received reflection wave,

the image generation apparatus including:

an acquisition unit that acquires, from the irradiation apparatus, the IF signal for determining a distance from a portion of the subject irradiated with the electromagnetic wave to the irradiation apparatus and an angle of the portion with reference to the irradiation apparatus;

an IF signal processing unit that generates, by processing the IF signal, three-dimensional positional information indicating a three-dimensional shape of the subject and an accompaniment of the subject; and

an image generation unit that generates, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction, and displaying the first two-dimensional image and the second two-dimensional image on a display unit.

The present invention provides an image generation method performed by a computer, in which

the computer is used together with an irradiation apparatus, and

the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,

the image generation method including:

by the computer,

acquiring, from the irradiation apparatus, the IF signal for determining a distance from a portion of the subject irradiated with the electromagnetic wave to the irradiation apparatus and an angle of the portion with reference to the irradiation apparatus;

generating, by processing the IF signal information, three-dimensional positional information indicating a three-dimensional shape of the subject and an accompaniment of the subject;

generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and

displaying the first two-dimensional image and the second two-dimensional image on a display unit.

The present invention provides a program executed by a computer being used together with an irradiation apparatus, in which

the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,

the program causing the computer to have:

a function of acquiring, from the irradiation apparatus, the IF signal for determining a distance from a portion of the subject irradiated with the electromagnetic wave to the irradiation apparatus and an angle of the portion with reference to the irradiation apparatus;

a function of generating, by processing the IF signal, three-dimensional positional information indicating a three-dimensional shape of the subject and an accompaniment of the subject;

a function of generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and

a function of displaying the first two-dimensional image and the second two-dimensional image on a display unit.

### Advantageous Effects of Invention

The present invention is able to efficiently cause an accompaniment to be recognized by a person when a three-dimensional shape of a subject and an accompaniment of the subject is estimated by irradiating an electromagnetic wave and analyzing a reflection wave of the electromagnetic wave.

### BRIEF DESCRIPTION OF THE DRAWINGS

The above-described object, the other objects, features, and advantages will become more apparent from a suitable example embodiment described below and the following accompanying drawings.

FIG. 1 is diagram for describing a usage environment of an image processing apparatus according to an example embodiment.

FIG. 2 is a diagram illustrating one example of a functional configuration of an irradiation apparatus.

FIG. 3 is a diagram illustrating one example of a functional configuration of the image processing apparatus.

FIG. 4 is a block diagram illustrating a hardware configuration of the image processing apparatus.

FIG. 5 is a flowchart illustrating one example of processing performed by an image generation unit of the image processing apparatus.

FIG. 6 is a diagram for describing a first example of a two-dimensional image generated by the image generation unit.

FIG. 7 is a diagram illustrating a first example of a method of generating a two-dimensional image.

FIG. 8 is a diagram illustrating the first example of the method of generating a two-dimensional image.

FIG. 9 is a diagram illustrating a second example of the method of generating a two-dimensional image.

FIG. 10 is a diagram illustrating an example of computing a reference point.

FIG. 11 is a diagram illustrating a first example of processing performed by the image generation unit on at least one two-dimensional image being generated.

FIG. 12 is a diagram illustrating a second example of the processing performed by the image generation unit on at least one two-dimensional image being generated.

### EXAMPLE EMBODIMENT

Hereinafter, an example embodiment of the present invention will be described with reference to the drawings. Note that, in all of the drawings, a similar component has a similar reference sign, and description thereof will be appropriately omitted.

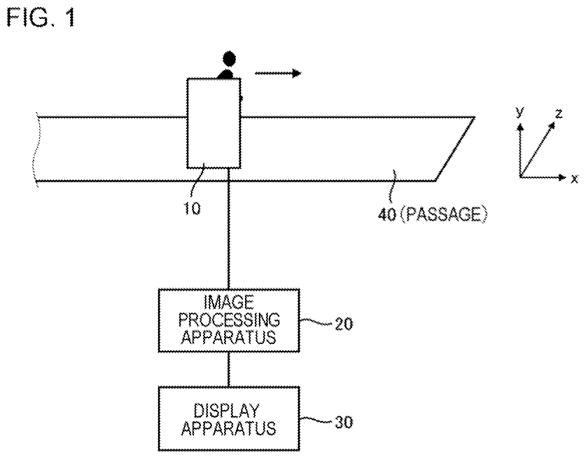

FIG. 1 is diagram for describing a usage environment of an image processing apparatus 20 according to an example embodiment. The image processing apparatus 20 is used together with an irradiation apparatus 10 and a display apparatus 30.

The irradiation apparatus 10 irradiates a subject such as a passer with an electromagnetic wave, and receives a reflection wave acquired from the electromagnetic wave being reflected by the subject. Furthermore, the irradiation apparatus 10 generates an intermediate frequency signal (IF signal) by performing frequency conversion on the received reflection wave into an intermediate frequency band.

As an electromagnetic wave irradiated by the irradiation apparatus 10, an electromagnetic wave having a wavelength that is transmitted through cloth (for example, clothing) but is reflected by a subject itself (for example, a human body) and an accompaniment of a subject is desirably used. As one example, the electromagnetic wave is a microwave, a millimeter wave, or a terahertz wave, and a wavelength is equal to or more than 30 micrometers and equal to or less than one meter. Note that, in FIG. 1, a horizontal direction of a plane onto which the irradiation apparatus irradiates an electromagnetic wave is an x-direction, a vertical direction (up-down direction) is a y-direction, and a direction in which an electromagnetic wave is irradiated is a z-direction. In other words, when viewed from a subject, a moving direction is substantially the x-direction, the up-down direction is the y-direction, and a direction substantially orthogonal to the moving direction of the subject is the z-direction.

Note that, in the example illustrated in FIG. 1, the irradiation apparatus 10 is disposed almost in parallel (i.e., almost 180°) with respect to a passage of a subject, but the irradiation apparatus 10 may be disposed at an angle (i.e., obliquely) other than 180° with respect to the passage.

The image processing apparatus 20 acquires an IF signal from the irradiation apparatus 10, and generates three-dimensional positional information indicating a three-dimensional shape of at least a part of a subject by processing the IF signal. The three-dimensional positional information includes information for determining each of a distance from a portion (reflection point) of a subject irradiated with an electromagnetic wave to the irradiation apparatus 10 and an angle of the reflection point with reference to the irradiation apparatus 10 (for example, an antenna included in a reception unit 130). The distance determined by the three-dimensional positional information may be, for example, a distance from a transmission antenna included in a transmission unit 110 described later to a target portion, a distance from a reception antenna included in the reception unit 130 to a target portion, or an average value of these distances.

Note that, it is preferable that the three-dimensional positional information also includes information about intensity of a reflection wave in each position. When a subject has an accompaniment (for example, belongings), the three-dimensional positional information is also information for determining a three-dimensional shape of at least a part of the accompaniment.

When there is an accompaniment on a subject, a three-dimensional shape indicated by the three-dimensional positional information also includes a three-dimensional shape of at least a part of the accompaniment. The image processing apparatus 20 generates at least a first two-dimensional image and a second two-dimensional image by processing the three-dimensional positional information. The first two-dimensional image is a two-dimensional image when a subject (including an accompaniment in a case of presence of the accompaniment: the same applies hereinafter) is viewed from a first direction. The second two-dimensional image is a two-dimensional image when the subject is viewed from a second direction. Then, the image processing apparatus 20 displays the two-dimensional images on the display apparatus 30.

Further, the image processing apparatus 20 also displays a three-dimensional image of a subject on the display apparatus 30. At this time, the image processing apparatus 20 can set the three-dimensional image in a predetermined orientation. In other words, the image processing apparatus 20 can rotate the three-dimensional image in response to a user input, for example, in such a way that the three-dimensional image is set in a predetermined orientation.

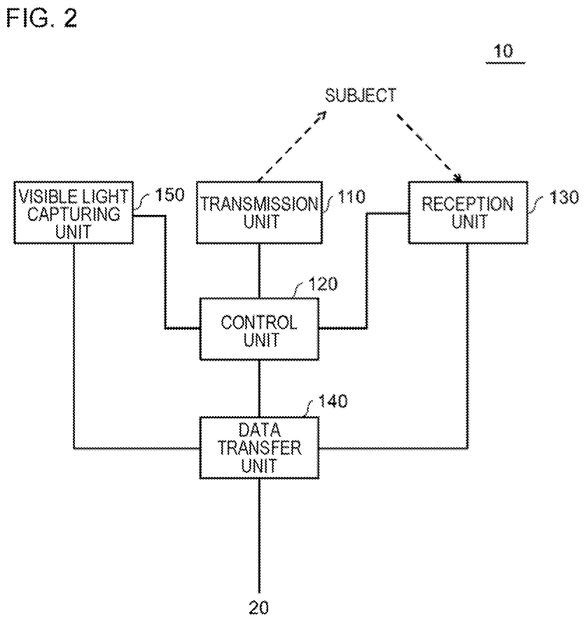

FIG. 2 is a diagram illustrating one example of a functional configuration of the irradiation apparatus 10. In the example illustrated in FIG. 2, the irradiation apparatus 10 includes the transmission unit 110, a control unit 120, the reception unit 130, and a data transfer unit 140.

The transmission unit 110 irradiates an electromagnetic wave toward a region (hereinafter described as an irradiation region) through which a subject passes. The transmission unit 110 includes, for example, an omnidirectional antenna. The transmission unit 110 can change a frequency of an electromagnetic wave in a fixed range. The transmission unit 110 is controlled by the control unit 120. Note that, the control unit 120 also controls the reception unit 130.

The reception unit 130 receives a reflection wave by a subject. The reception unit 130 generates an intermediate frequency signal (IF signal) by performing frequency conversion on the received reflection wave into an intermediate frequency band. The control unit 120 performs control for setting an intermediate frequency band in the reception unit 130 to an appropriate value.

In the example illustrated in FIG. 2, the irradiation apparatus 10 further includes a visible light capturing unit 150. The visible light capturing unit 150 is controlled by the control unit 120, and generates a visible light image being an image of a subject by visible light. The visible light capturing unit 150 is controlled by the control unit 120. Then, the control unit 120 synchronizes a capturing timing by the visible light capturing unit 150 and an irradiation timing by the transmission unit 110. The synchronization herein also includes a case where there is a fixed time difference in addition to a case of the same time. The visible light capturing unit 150 faces, for example, in a direction in which a subject is captured from the side, i.e., in the z-direction in FIG. 1. However, an orientation of the visible light capturing unit 150 is not limited to this.

The data transfer unit 140 acquires an IF signal generated in the reception unit 130, and outputs the IF signal to the image processing apparatus 20. Furthermore, it is desired that the data transfer unit 140 also outputs a time of transmission or a time at which an IF signal is generated (hereinafter also described as time information) to the image processing apparatus 20. Furthermore, the data transfer unit 140 also outputs a visible light image generated by the visible light capturing unit 150 to the image processing apparatus 20.

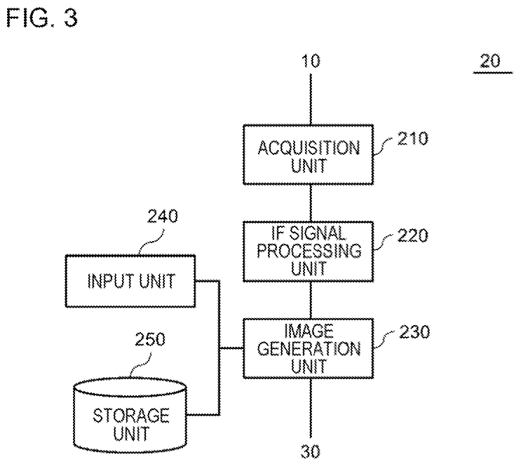

FIG. 3 is a diagram illustrating one example of a functional configuration of the image processing apparatus 20. The image processing apparatus 20 includes at least an acquisition unit 210, an IF signal processing unit 220, and an image generation unit 230. The acquisition unit 210 acquires an IF signal from the irradiation apparatus 10. The IF signal processing unit 220 generates three-dimensional positional information about reflection intensity from a subject by processing an IF signal. In other words, when the IF signal processing unit 220 generates three-dimensional positional information, the IF signal processing unit 220 computes an arrival angle (i.e., an angle of the reflection point described above) of a reflection wave together with a distance from the irradiation apparatus 10 to the reflection point. The image generation unit 230 generates at least a first two-dimensional image and a second two-dimensional image from information about a three-dimensional distribution of reflection intensity from a subject, and displays the two-dimensional images on the display apparatus 30. Details of generation processing of a two-dimensional image by the image generation unit 230 will be described later by using another diagram.

When the image generation unit 230 displays two-dimensional information on the display apparatus 30, the image generation unit 230 may display, on the display apparatus 30, a visible light image generated by the visible light capturing unit 150 of the irradiation apparatus 10 simultaneously with or at a different timing from the two-dimensional images. Furthermore, the image generation unit 230 may display, on the display apparatus 30, a distance from the irradiation apparatus 10 to a subject. At this time, when a predetermined position of a two-dimensional image is selected (for example, when selection by a cursor is performed), the image generation unit 230 may display, on the display apparatus 30, distance information about the position (or the distance from the irradiation apparatus 10 to the subject).

Further, the image generation unit 230 may display information about a three-dimensional distribution of reflection intensity. Herein, the image generation unit 230 may generate a three-dimensional image of a subject by processing the information about the three-dimensional distribution, and may display the three-dimensional image on the display apparatus 30.

The image processing apparatus 20 illustrated in FIG. 3 further includes an input unit 240 and a storage unit 250.

The input unit 240 acquires an input from a user. The input includes information that specifies a first direction (i.e., a direction of a first two-dimensional image) and a second direction (i.e., a direction of a second two-dimensional image), for example. Note that, when the first direction and the second direction are set as default and the default directions are used, the input unit 240 may not acquire the input.

Further, when the image generation unit 230 displays a three-dimensional image of a subject on the display apparatus 30, the input unit 240 acquires information indicating an orientation of the three-dimensional image. Then, the image generation unit 230 generates a three-dimensional image in the orientation acquired by the input unit 240, and displays the three-dimensional image on the display apparatus 30.

The storage unit 250 stores information acquired and information generated by the image processing apparatus 20. As one example, the storage unit 250 stores three-dimensional positional information. When time information is transmitted together with an IF signal from the irradiation apparatus 10, the storage unit 250 also stores, in association with three-dimensional positional information, time information relating to the IF signal used for generating the three-dimensional positional information.

Further, the image generation unit 230 can also determine a kind of an accompaniment (for example, a kind of belongings) by processing three-dimensional positional information or a two-dimensional image. In this case, the storage unit 250 also stores, in association with three-dimensional positional information, a kind of an accompaniment included in the three-dimensional positional information.

Then, the image generation unit 230 reads the three-dimensional positional information from the storage unit 250 according to information input from the input unit 240, for example. Then, the image generation unit 230 generates a first two-dimensional image and a second two-dimensional image by using the read three-dimensional positional information, and displays the first two-dimensional image and the second two-dimensional image on the display apparatus 30.

Further, the storage unit 250 can also store predetermined information (for example, at least one of a two-dimensional image generated by the image generation unit 230, presence or absence of an accompaniment, and a kind of the accompaniment) together with three-dimensional positional information. In this case, the image generation unit 230 reads the predetermined information from the storage unit 250 according to information input from the input unit 240, for example, performs statistical processing on the predetermined information, and displays a result of the statistical processing on the display apparatus 30. One example of a result of the statistical processing is, for example, the amount of an accompaniment detected between a first date and time and a second date and time, or the amount of an accompaniment by kind.

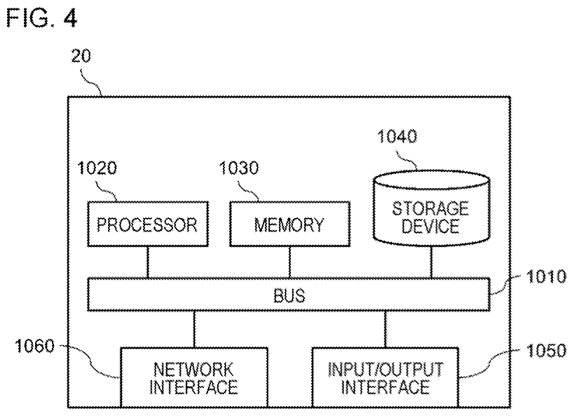

FIG. 4 is a block diagram illustrating a hardware configuration of the image processing apparatus 20. The image processing apparatus 20 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage achieved by a random access memory (RAM) and the like.

The storage device 1040 is an auxiliary storage achieved by a hard disk drive (HDD), a solid state drive (SSD), a memory card, a read only memory (ROM), or the like. The storage device 1040 stores a program module that achieves each function (for example, the acquisition unit 210 , the IF signal processing unit 220, and the image generation unit 230) of the image processing apparatus 20. The processor 1020 reads each program module onto the memory 1030 and executes the program module, and each function associated with the program module is achieved. Further, the storage device 1040 also functions as various storage units (for example, the storage unit 250).

The input/output interface 1050 is an interface for connecting the image processing apparatus 20 and various types of input/output equipment (for example, the input unit 240).

The network interface 1060 is an interface for connecting the image processing apparatus 20 to another apparatus (for example, the irradiation apparatus 10) on a network. However, the network interface 1060 may not be used.

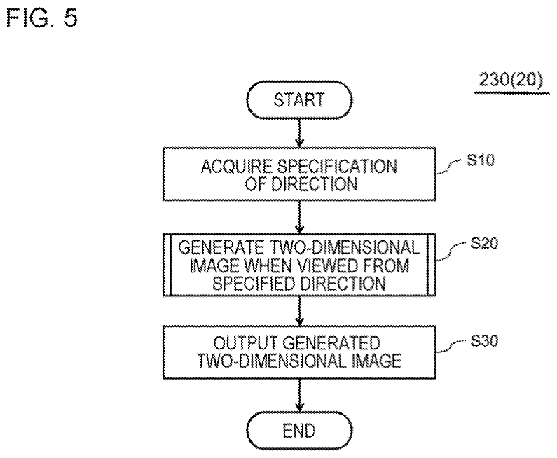

FIG. 5 is a flowchart illustrating one example of processing performed by the image generation unit 230 of the image processing apparatus 20. First, the image generation unit 230 acquires, via the input unit 240, a specification of a direction of a two-dimensional image that needs to be generated by the image generation unit 230 (step S10). The direction specified herein includes the first direction and the second direction described above. Note that, a direction may not be specified herein. In this case, the image generation unit 230 uses a direction specified as default.

Next, the image generation unit 230 generates a plurality of two-dimensional images by processing three-dimensional positional information about reflection intensity from a subject being generated by the IF signal processing unit 220 (step S20). Then, the image generation unit 230 outputs the generated two-dimensional images to the display apparatus 30, and displays the two-dimensional images (step S30).

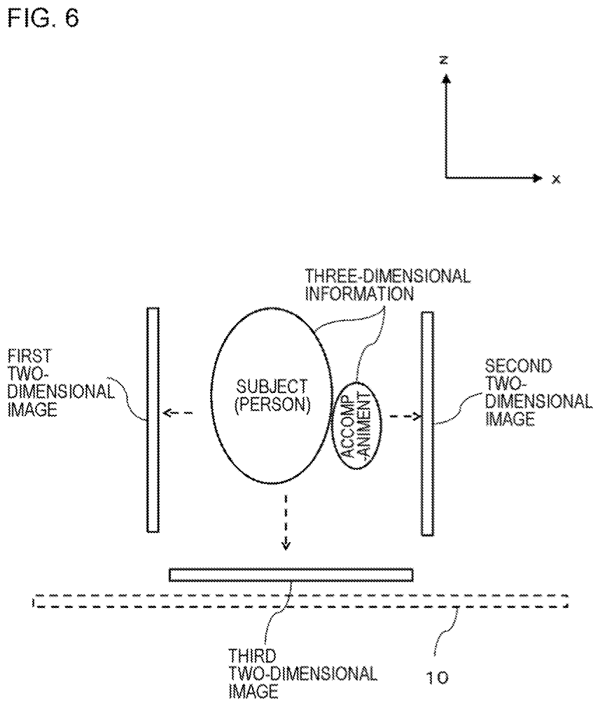

FIG. 6 is a diagram for describing a first example of a two-dimensional image generated by the image generation unit 230. In the example illustrated in FIG. 6, the image generation unit 230 can generate an image (one example of a first two-dimensional image) when viewed from a direction in which a subject moves, an image (one example of a second two-dimensional image) when viewed from an opposite direction to the moving direction of the subject), an image when the subject is viewed from the side, and an image (for example, a third two-dimensional image) when the subject is viewed from the irradiation apparatus 10 side. Note that, the image generation unit 230 can also generate a two-dimensional image when a subject is viewed from above. When a subject is a person and an accompaniment is belongings of the person, a person who looks at the display apparatus 30 easily recognizes a shape of the belongings carried by the person with a first two-dimensional image and a second two-dimensional image in such an orientation (for example, a direction moved from a back and a direction moved from the front).

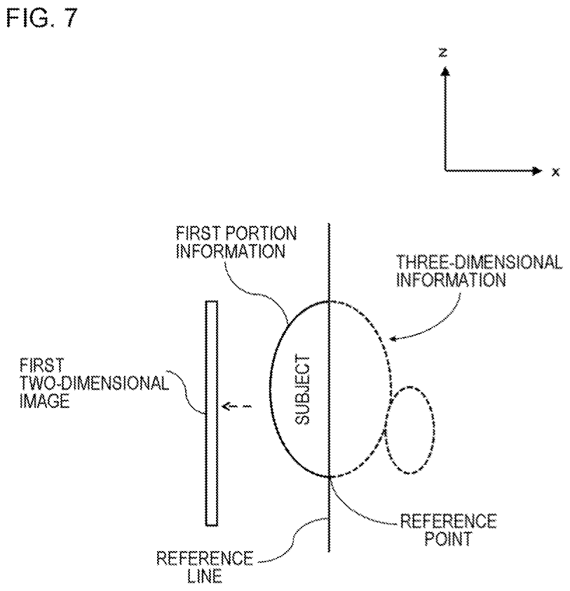

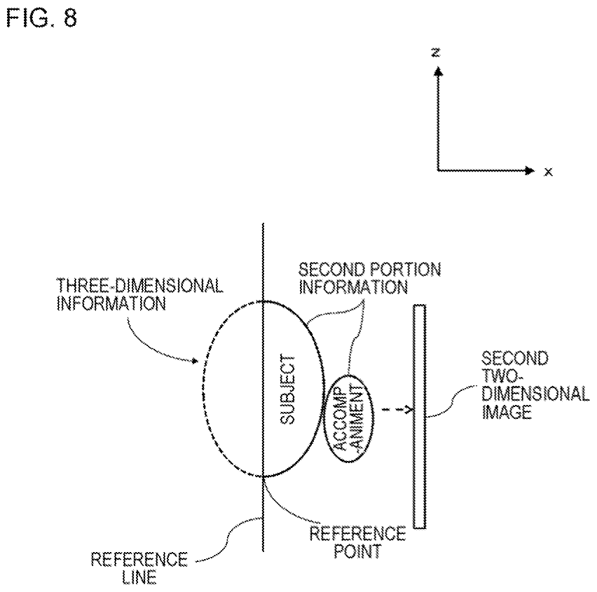

FIGS. 7 and 8 are diagrams illustrating a first example of a method of generating a two-dimensional image. FIG. 7 illustrates a method of generating a first two-dimensional image, and FIG. 8 illustrates a method of generating a second two-dimensional image. In the examples illustrated in FIGS. 7 and 8, the image generation unit 230 sets a reference point being a part of a subject, based on three-dimensional positional information about reflection intensity from the subject being generated by the IF signal processing unit 220, and divides the three-dimensional positional information into first portion information and second portion information with reference to the reference point. Then, the image generation unit 230 generates the first two-dimensional image by processing the first portion information, and generates the second two-dimensional image by processing the second portion information.

For example, in the example illustrated in FIGS. 7 and 8, the first two-dimensional image is an image when viewed from a direction in which a subject moves, and the second two-dimensional image is an image when viewed from an opposite direction. In other words, a first direction is a direction in which a subject moves, and a second direction is an opposite direction to the first direction.

Then, the image generation unit 230 sets a specific portion of a three-dimensional shape of a subject as a reference point. For example, the image generation unit 230 may set, as a reference point, a portion of a three-dimensional shape associated with a reflection wave having the highest intensity. Alternatively, the image generation unit 230 may set, as a reference point, a center of gravity of three-dimensional subject reflection intensity, or may set, as a reference point, a central point of a portion having three-dimensional subject reflection intensity that exceeds a certain threshold value.

Then, a line passing through the reference point is a reference line. Then, the image generation unit 230 divides three-dimensional positional information into first portion information being information (i.e., information located behind the reference point) located behind the reference line in the first direction, i.e., the direction in which the subject moves, and a remaining portion (i.e., information located in front of the reference point in the first direction).

Then, the image generation unit 230 generates a first two-dimensional image by using the first portion information, and generates a second two-dimensional image by using second portion information. With this configuration, when the first two-dimensional image is generated, the second portion information (i.e., information about a portion constituting the second two-dimensional image) does not enter, and, as a result, image quality of the first two-dimensional image improves. Similarly, when the second two-dimensional image is generated, the first portion information does not enter, and, as a result, image quality of the second two-dimensional image improves.

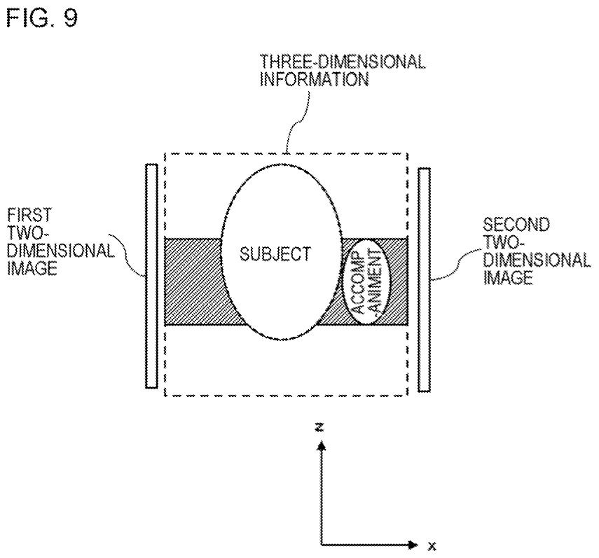

FIG. 9 is a diagram illustrating a second example of the method of generating a two-dimensional image. In the example illustrated in FIG. 9, the image generation unit 230 determines a portion of three-dimensional positional information overlapping an accompaniment when viewed from a first direction, and overwrites, with another piece of data (for example, 0 value), a region (a region other than a hatched region in FIG. 9) of the portion other than a subject and the accompaniment. Then, the image generation unit 230 generates a first two-dimensional image and a second two-dimensional image by using the overwritten three-dimensional positional information. With this configuration, there is a lower possibility that noise occurs when the two-dimensional images are generated. Thus, image quality of the two-dimensional images improves.

Note that, in the processing described by using FIG. 9, the image generation unit 230 may replace, with another piece of data, a region other than an accompaniment of a portion overlapping the accompaniment when viewed from the first direction. Furthermore, the image generation unit 230 may determine a portion overlapping at least one of an accompaniment and a subject when viewed from the first direction, and may overwrite, with another piece of data (for example, 0 value), a region (a hatched region in FIG. 9) of the portion other than the subject and the accompaniment.

Further, the image generation unit 230 may determine a portion overlapping an accompaniment when viewed from another direction (for example, a direction parallel to a y-axis and/or a direction parallel to a z-axis) by performing processing similar to the example illustrated in FIG. 9, and may overwrite, with another piece of data (for example, 0 value), a region of the portion other than a subject and the accompaniment. Also in this case, the image generation unit 230 generates a first two-dimensional image and a second two-dimensional image by using the overwritten three-dimensional positional information.

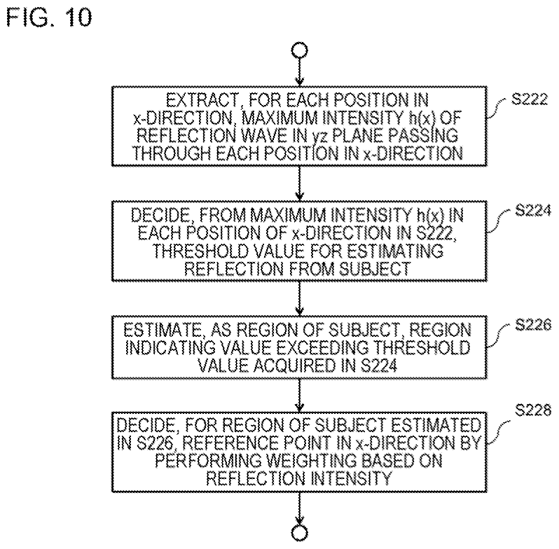

FIG. 10 is a flowchart illustrating one example of a method of computing a reference point. In the example illustrated in FIG. 10, the image generation unit 230 first extracts, by position in the x-direction, maximum intensity h of a reflection wave in a yz plane passing through the position in the x-direction by processing three-dimensional positional information (step S222). By the step S222, a function h(x) in which a position x in the x-direction is a domain and the maximum intensity h of a reflection wave is a range can be defined.

Next, the image generation unit 230 decides, by using the maximum intensity h(x) by position of x being acquired in the step S222, a threshold value for estimating reflection from a subject (step S224). As one example of a method of deciding a threshold value, an average value of a maximum value and a minimum value of the function h(x) being acquired in the step S222 may be set as a threshold value.

Next, the image generation unit 230 estimates, as a region of the subject, a region indicating a greater value than the threshold value (step S226).

Next, the image generation unit 230 decides, for the estimated region of the subject, a reference point in the x-direction by performing weighting based on reflection intensity (step S228).

Note that, the image generation unit 230 may generate a two-dimensional image as follows. First, a direction in which three-dimensional positional information needs to be projected, i.e., a direction (for example, a first direction or a second direction) of a line of sight of a two-dimensional image that needs to be generated is set. Then, by using the set projection direction, a plurality of pixels (hereinafter described as three-dimensional pixels) constituting three-dimensional positional information are assigned to each pixel (hereinafter described as a two-dimensional pixel) constituting a two-dimensional image. As one example, the image generation unit 230 assigns, to the same two-dimensional pixel, pixels of three-dimensional pixels that overlap each other when viewed from a set projection direction. Then, a maximum value of the assigned pixels of the three-dimensional positional information is determined by pixel constituting the two-dimensional image, and the determined maximum value is set as a value of the pixel constituting the two-dimensional image.

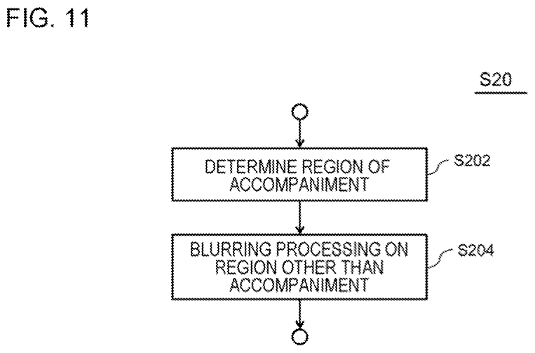

FIG. 11 is a diagram illustrating a first example of processing performed by the image generation unit 230 on at least one two-dimensional image (for example, at least one of a first two-dimensional image and a second two-dimensional image) being generated. The processing illustrated in FIG. 11 is processing for making an accompaniment easier to be seen. First, the image generation unit 230 determines a region of an accompaniment in a two-dimensional image (step S202). For example, the image generation unit 230 determines a region of an accompaniment by using a detection result in which machine learning is performed with, as an input, a two-dimensional image or a three-dimensional image including a subject and the accompaniment. Then, the image generation unit 230 performs processing of reducing a resolution on a region other than the accompaniment in the two-dimensional image or the three-dimensional image. In this way, a processed image is generated (step S204). One example of the processing is smoothing processing, and is processing of replacing a value of each pixel with an average value of the value of the pixel and a value of a pixel in the vicinity.

Note that, the image generation unit 230 may also apply, to an accompaniment, the smoothing processing, based on a likelihood output from a detector. For example, when a likelihood is high, it is desired that the smoothing processing is not performed. On the other hand, when a likelihood is low, it is desired that the smoothing processing is performed.

The image generation unit 230 displays the generated processed image on the display apparatus 30.

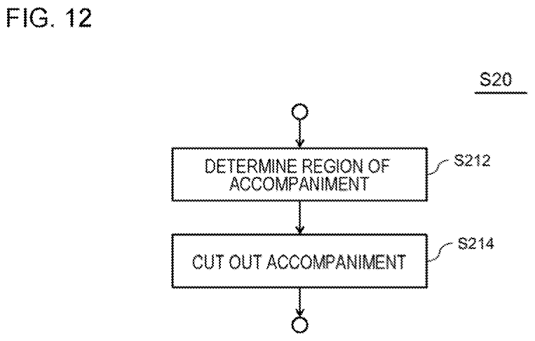

FIG. 12 is a diagram illustrating a second example of the processing performed by the image generation unit 230 on at least one two-dimensional image (for example, at least one of a first two-dimensional image and a second two-dimensional image) being generated. The processing illustrated in FIG. 12 is also processing for making an accompaniment easier to be seen. First, the image generation unit 230 determines a region of an accompaniment in a two-dimensional image (step S212). Then, the image generation unit 230 replaces, with another piece of data, a pixel of a region other than the accompaniment in the two-dimensional image. The other piece of data is data indicating, for example, a specific color (for example, white). In this way, a processed image acquired by cutting out the accompaniment is generated (step S214). In this case, information about a subject is not included in the two-dimensional image, and thus, when the subject is a person, personal information about the person can be protected.

Note that, in the examples illustrated in FIGS. 11 and 12, the image generation unit 230 may display, on the display apparatus 30, a processed image together with an image before processing, or may display only a processed image on the display apparatus 30. Further, the image generation unit 230 may switch, in response to an input from the input unit 240, between a first mode of displaying a two-dimensional image before processing on the display apparatus 30 and a second mode of displaying a processed image on the display apparatus 30. With this configuration, when a two-dimensional image before processing is desired to be viewed, the image can be viewed, and, when a processed image is also desired to be viewed, the image can be viewed.

For the example embodiment of the present invention with reference to the drawings, the present invention is exemplified above with reference to the x-axis, the y-axis, and the z-axis based on a plane irradiated with an electromagnetic wave by an irradiation apparatus. However, the x-axis, the y-axis, and the z-axis do not necessarily need to be reference axes, and similar processing to that in the example embodiment of the present invention may be performed by using any three axes expressed by three linearly independent vectors.

As described above, according to the present example embodiment, the image processing apparatus 20 generates three-dimensional positional information indicating a three-dimensional shape of a subject and an accompaniment of the subject by using an IF signal generated by the irradiation apparatus 10. Then, the image processing apparatus 20 can generate, by using the three-dimensional positional information, two-dimensional images when viewed from a plurality of directions. Thus, the two-dimensional image from a direction in which the accompaniment can be viewed in an excellent manner can be generated, and thus the accompaniment can be efficiently recognized by a person.

While the example embodiment of the present invention has been described with reference to the drawings, the example embodiment is only exemplification of the present invention, and various configurations other than the above-described example embodiment can also be employed.

Further, the plurality of steps (processing) are described in order in the plurality of flowcharts used in the above-described description, but an execution order of steps performed in each example embodiment is not limited to the described order. In each example embodiment, an order of illustrated steps may be changed within an extent that there is no harm in context. Further, each example embodiment described above can be combined within an extent that a content is not inconsistent.

A part or the whole of the above-described example embodiment may also be described in supplementary notes below, which is not limited thereto.

1. An image generation apparatus used together with an irradiation apparatus, the irradiation apparatus including

a transmission unit that irradiates a region through which a subject passes with an electromagnetic wave having a wavelength of equal to or more than 30 micrometers and equal to or less than one meter, and

a reception unit that receives a reflection wave acquired from the electromagnetic wave being reflected by the subject, and generates an IF signal being an intermediate frequency signal from the received reflection wave,

the image generation apparatus including:

an acquisition unit that acquires, from the irradiation apparatus, the IF signal for determining a distance from a portion of the subject irradiated with the electromagnetic wave to the irradiation apparatus and an angle of the portion with reference to the irradiation apparatus;

a processing unit that generates, by processing the IF signal, three-dimensional positional information indicating a three-dimensional shape of the subject and an accompaniment of the subject; and

an image generation unit that generates, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction, and displays the first two-dimensional image and the second two-dimensional image on a display unit.

2. The image generation apparatus according to supplementary note 1, in which

the image generation unit
sets a reference point being a part of the subject by using the three-dimensional positional information,
divides the three-dimensional positional information into first portion information and second portion information with reference to the reference point, and
generates the first two-dimensional image by processing the first portion information, and generates the second two-dimensional image by processing the second portion information.

3. The image generation apparatus according to supplementary note 2, in which

the first direction is a direction in which the subject moves,

the second direction is an opposite direction to the first direction, and

the image generation unit
generates intensity of the reflection wave by processing the IF signal,
sets the reference point being a part of the three-dimensional shape, based on the intensity of the reflection wave, and also sets a reference line passing through the reference point, and
sets, as the first portion information, a portion located behind the reference line in the first direction, and sets the second portion information located in front of the reference line in the first direction.

4. The image generation apparatus according to any one of supplementary notes 1 to 3, in which

the image generation unit
determines a portion of the three-dimensional positional information overlapping the accompaniment when viewed from the first direction, and overwrites, with another piece of data, a region of the portion other than the subject and the accompaniment, and
generates the first two-dimensional image by using the overwritten three-dimensional positional information.

5. The image generation apparatus according to any one of supplementary notes 1 to 4, in which

the image generation unit generates a processed image by making a resolution of a region of the subject other than the accompaniment lower than a resolution of the accompaniment in at least one of the first two-dimensional image and the second two-dimensional image, and displays the processed image on the display unit.

6. The image generation apparatus according to any one of supplementary notes 1 to 4, in which

the image generation unit generates a processed image acquired by cutting out the accompaniment from at least one of the first two-dimensional image and the second two-dimensional image, and displays the processed image on the display unit.

7. The image generation apparatus according to supplementary note 5 or 6, in which

the image generation unit has a first mode of displaying the at least one on the display unit, and a second mode of displaying the processed image on the display unit.

8. An image generation method performed by a computer, in which

the computer is used together with an irradiation apparatus, and

the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,

the image generation method including:

by the computer,
acquiring, from the irradiation apparatus, the IF signal for determining a distance from a portion of the subject irradiated with the electromagnetic wave to the irradiation apparatus and an angle of the portion with reference to the irradiation apparatus;
generating, by processing the IF signal, three-dimensional positional information indicating a three-dimensional shape of the subject and an accompaniment of the subject;
generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and
displaying the first two-dimensional image and the second two-dimensional image on a display unit.

9. The image generation method according to supplementary note 8, in which

the computer
sets a reference point being a part of the subject by using the three-dimensional positional information,
divides the three-dimensional positional information into first portion information and second portion information with reference to the reference point, and
generates the first two-dimensional image by processing the first portion information, and generates the second two-dimensional image by processing the second portion information.

10. The image generation method according to supplementary note 9, in which

the first direction is a direction in which the subject moves,

the second direction is an opposite direction to the first direction, and

the computer
generates intensity of the reflection wave by processing the IF signal,
sets the reference point by using the reflection wave, and also sets a reference line passing through the reference point, and
sets, as the first portion information, a portion located behind the reference line in the first direction, and sets the second portion information located in front of the reference line in the first direction.

11. The image generation method according to any one of supplementary notes 8 to 10, in which

the computer
determines a portion of the three-dimensional positional information overlapping the accompaniment when viewed from the first direction, and overwrites, with another piece of data, a region of the portion other than the subject and the accompaniment, and
generates the first two-dimensional image by using the overwritten three-dimensional positional information.

12. The image generation method according to any one of supplementary notes 8 to 11, in which

the computer generates a processed image by making a resolution of a region of the subject other than the accompaniment lower than a resolution of the accompaniment in at least one of the first two-dimensional image and the second two-dimensional image, and displays the processed image on the display unit.

13. The image generation method according to any one of supplementary notes 8 to 11, in which

the computer generates a processed image acquired by cutting out the accompaniment from at least one of the first two-dimensional image and the second two-dimensional image, and displays the processed image on the display unit.

14. The image generation method according to supplementary note 12 or 13, in which

the computer has a first mode of displaying the at least one on the display unit, and a second mode of displaying the processed image on the display unit.

15. A program executed by a computer being used together with an irradiation apparatus, in which

the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,

the program causing the computer to have:
a function of acquiring, from the irradiation apparatus, the IF signal for determining a distance from a portion of the subject irradiated with the electromagnetic wave to the irradiation apparatus and an angle of the portion with reference to the irradiation apparatus;
a function of generating, by processing the IF signal, three-dimensional positional information indicating a three-dimensional shape of the subject and an accompaniment of the subject;
a function of generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and
a function of displaying the first two-dimensional image and the second two-dimensional image on a display unit.

16. The program according to supplementary note 15, further causing the computer to have:

a function of setting a reference point being a part of the subject by using the three-dimensional positional information;

a function of dividing the three-dimensional positional information into first portion information and second portion information with reference to the reference point; and

a function of generating the first two-dimensional image by processing the first portion information, and generating the second two-dimensional image by processing the second portion information.

17. The program according to supplementary note 16, in which

the first direction is a direction in which the subject moves, and

the second direction is an opposite direction to the first direction,

the program further causing the computer to have:

a function of generating intensity of the reflection wave by processing the IF signal;

a function of setting the reference point by using the intensity of the reflection wave, and also setting a reference line passing through the reference point; and

a function of setting, as the first portion information, a portion located behind the reference line in the first direction, and setting the second portion information located in front of the reference line in the first direction.

18. The program according to any one of supplementary notes 15 to 17, further causing the computer to have:

a function of determining a portion of the three-dimensional positional information overlapping the accompaniment when viewed from the first direction, and overwriting, with another piece of data, a region of the portion other than the subject and the accompaniment; and

a function of generating the first two-dimensional image by using the overwritten three-dimensional positional information.

19. The program according to any one of supplementary notes 15 to 18, further causing the computer to have

a function of generating a processed image by making a resolution of a region of the subject other than the accompaniment lower than a resolution of the accompaniment in at least one of the first two-dimensional image and the second two-dimensional image, and displaying the processed image on the display unit.

20. The program according to any one of supplementary notes 15 to 18, further causing the computer to have

a function of generating a processed image acquired by cutting out the accompaniment from at least one of the first two-dimensional image and the second two-dimensional image, and displaying the processed image on the display unit.

21. The program according to supplementary note 19 or 20, further causing the computer to have

a first mode of displaying the at least one on the display unit, and a second mode of displaying the processed image on the display unit.

### REFERENCE SIGNS LIST

10 Irradiation apparatus
20 Image processing apparatus
30 Display apparatus
110 Transmission unit
120 Control unit
130 Reception unit
140 Data transfer unit
150 Visible light capturing unit
210 Acquisition unit
220 IF signal processing unit
230 Image generation unit
240 Input unit
250 Storage unit

What is claimed is:

1. An image generation apparatus used together with an irradiation apparatus, the irradiation apparatus comprising
a transmitter that irradiates a region through which a subject passes with an electromagnetic wave having a wavelength of equal to or more than 30 micrometers and equal to or less than one meter, and
a receiver that receives a reflection wave acquired from the electromagnetic wave being reflected by the subject, and generates an IF signal being an intermediate frequency signal from the received reflection wave,
the image generation apparatus comprising:
at least one memory configured to store instructions; and
at least one processor configured to execute the instructions to perform operations comprising:
acquiring, from the irradiation apparatus, the IF signal for determining a distance from a portion of the subject irradiated with the electromagnetic wave to the irradiation apparatus and an angle of the portion with reference to the irradiation apparatus;
generating, by processing the IF signal, three-dimensional positional information indicating a three-dimensional shape of the subject and an accompaniment of the subject;
generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and
displaying the first two-dimensional image and the second two-dimensional image on a display.

2. The image generation apparatus according to claim 1, wherein
the operations further comprise:
setting a reference point being a part of the subject by using the three-dimensional positional information;
dividing the three-dimensional positional information into first portion information and second portion information with reference to the reference point;
generating the first two-dimensional image by processing the first portion information; and
generating the second two-dimensional image by processing the second portion information.

3. The image generation apparatus according to claim 2, wherein
the first direction is a direction in which the subject moves,
the second direction is an opposite direction to the first direction, and
the operations further comprise:
generating intensity of the reflection wave by processing the IF signal;
setting the reference point by using the intensity of the reflection wave;
setting a reference line passing through the reference point;
setting, as the first portion information, a portion located behind the reference line in the first direction; and
setting, as the second portion information, a portion located in front of the reference line in the first direction.

4. The image generation apparatus according to claim 1, wherein
the operations further comprise:
determining a portion of the three-dimensional positional information overlapping the accompaniment when viewed from the first direction;
overwriting, with another piece of data, a region of the portion other than the subject and the accompaniment; and
generating the first two-dimensional image by using the overwritten three-dimensional positional information.

5. The image generation apparatus according to claim 1, wherein
the operations further comprise:
generating a processed image by making a resolution of a region of the subject other than the accompaniment lower than a resolution of the accompaniment in at least one of the first two-dimensional image and the second two-dimensional image; and
displaying the processed image on the display.

6. The image generation apparatus according to claim 1, wherein
the operations further comprise:
generating a processed image acquired by cutting out the accompaniment from at least one of the first two-dimensional image and the second two-dimensional image; and
displaying the processed image on the display.

7. The image generation apparatus according to claim 5, wherein
the operation further comprise switching a first mode of displaying the at least one on the display, and a second mode of displaying the processed image on the display.

8. An image generation method performed by a computer, wherein
the computer is used together with an irradiation apparatus, and
the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,
the image generation method comprising:
by the computer,
acquiring, from the irradiation apparatus, the IF signal for determining a distance from a portion of the subject irradiated with the electromagnetic wave to the irradiation apparatus and an angle of the portion with reference to the irradiation apparatus;
generating, by processing the IF signal, three-dimensional positional information indicating a three-dimensional shape of the subject and an accompaniment of the subject;
generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and
displaying the first two-dimensional image and the second two-dimensional image on a display.

9. A non-transitory computer readable medium storing a program executed by a computer being used together with an irradiation apparatus, wherein
the irradiation apparatus irradiates a region through which a subject passes with an electromagnetic wave having a wavelength of equal to or more than 30 micrometers and equal to or less than one meter, receives a reflection wave acquired from the electromagnetic wave being reflected by the subject, and generates an IF signal being an intermediate frequency signal from the received reflection wave,
the program causing the computer to execute operations comprising:
acquiring, from the irradiation apparatus, the IF signal for determining a distance from a portion of the subject irradiated with the electromagnetic wave to the irradiation apparatus and an angle of the portion with reference to the irradiation apparatus;
generating, by processing the IF signal, three-dimensional positional information indicating a three-dimensional shape of the subject and an accompaniment of the subject;
generating, by processing the three-dimensional positional information, at least a first two-dimensional image being a two-dimensional image when the subject and the accompaniment are viewed from a first direction, and a second two-dimensional image being a two-dimensional image when the subject and the accompaniment are viewed from a second direction; and
displaying the first two-dimensional image and the second two-dimensional image on a display.
